(19) United States
(12) Patent Application Publication
(10) Pub. No.: US 2018/0059007 A1
(43) Pub. Date: Mar. 1, 2018

(54) DEVICE AND METHOD FOR IN VITRO EVALUATION OF CLEANSERS

(71) Applicant: L'Oreal, Paris (FR)

(72) Inventors: Axelle Clochard, Clark, NJ (US); Theresa Phamduy, Jersey City, NJ (US); Kelsey Norwood, Scotch Plains, NJ (US); Gregory Peterson, Seattle, WA (US)

(73) Assignee: L'Oreal, Paris (FR)

(21) Appl. No.: 15/253,518

(22) Filed: Aug. 31, 2016

(51) Int. Cl. G01N 21/27; G01N 21/25; G01N 19/06

(52) U.S. Cl. CPC G01N 21/27; G01N 2201/12; G01N 19/06; G01N 21/251

(57) ABSTRACT

An in vitro screening system includes a friction assembly including at least one motorized friction structural component configured to engage and remove material on a substrate and an analytics assembly including at least one sensor and circuitry configured to generate cleanser-specific material removal information responsive to a detected response associated with removal of a material on a substrate by the friction structural component.

### SUMMARY

An in vitro screening system includes a friction assembly including at least one motorized friction structural component configured to engage and remove material on a substrate and an analytics assembly including at least one sensor and circuitry configured to generate cleanser-specific material removal information responsive to a detected response associated with removal of a material on a substrate by the friction structural component.

A method of evaluating the cleansing capability of a cleanser for removing a challenge material on a target area of a substrate includes delivering a motorized rubbing motion to the target area of the substrate including a challenge material with a motorized friction structural component and generating cleanser-specific material removal information responsive to detecting a plurality of electromagnetic responses associated with delivering the motorized rubbing motion to the target area of the substrate including the challenge material.

This summary is provided to introduce a selection of concepts in a simplified form, which are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is an exemplary pictorial depiction of an in vitro screening system having a friction assembly in communication with an analytics assembly;

FIG. 2 is a top isometric environmental view of a friction assembly for use in the in vitro screening system of FIG. 1, wherein the friction assembly is shown having a plurality of friction devices for engaging and removing a challenge material on a substrate;

FIG. 3 is a bottom isometric environmental view of the friction assembly of FIG. 2;

FIG. 4 is an isometric view of a friction device of FIG. 2;

FIG. 5 is an isometric exploded view of the friction device of FIG. 4;

FIG. 6 is an exemplary pictorial depiction of computer architecture for a computing device of the analytics assembly of FIG. 1;

FIG. 7A is an illustration of a preliminary step of an exemplary prior art in vivo method of generating cleanser-specific material removal information, wherein the substrate is a human arm that has six designated target areas;

FIG. 7B is an illustration of a subsequent step of the exemplary prior art in vivo method of generating cleanser-specific material removal information, wherein the challenge material has been applied to target areas 1, 3, 4, 5, and 6 shown in FIG. 7A;

FIG. 7C is an illustration of another subsequent step of the exemplary prior art in vivo method of generating cleanser-specific material removal information, wherein a cleanser has been used to cleanse each of the six target areas;

FIG. 8A is an illustration of a preliminary step of an in vitro method of generating cleanser-specific material removal information, wherein the preliminary step involves applying challenge material to a target area of a substrate;

FIG. 8B is an illustration of a subsequent step of the in vitro method of generating cleanser-specific material removal information, wherein the subsequent step involves applying cleanser to the target area on the substrate having challenge material and using the friction device of FIGS. 4 and 5 to remove at least a portion of the challenge material with the cleanser;

FIG. 9A is a graphical depiction of cleanser-specific material removal information using the in vitro method of FIGS. 8A-8B; and

FIG. 9B is a graphical depiction of cleanser-specific material removal information using the exemplary prior art in vivo method of FIGS. 7A-7C.

### DETAILED DESCRIPTION

Cleansers and other formulas (hereinafter “cleansers”), are used to remove challenge materials from skin or other human or artificial skin substrates, such as BioSkin or any other type of surface. Challenge materials on skin may include cosmetic materials, such as lipstick, eye shadow, foundation, etc., or other pollutant materials, such as sebum, dirt, etc. To date, cleanser efficacy evaluation has been done through in vivo testing. In general, in vivo testing involves applying a challenge material to a designated area of human skin and using a selected cleanser to remove the challenge material from the skin. In general, images of the designated skin area are taken before the challenge material is applied and after the challenge material is at least partially removed by the cleanser. The images are then compared to determine the cleanser efficacy.

The in vivo testing process is extremely time consuming and costly. As one skilled in the art can appreciate, the in vivo process requires human participants on which the cleansers must be tested. Limited skin areas on a participant are suitable for testing, which means that the number of cleansers and challenge materials that may be tested per study is limited. Moreover, the testing process is labor intensive, requiring multiple operators to be present to conduct the tests. Further, the overall in vivo testing time can take many hours, and the participants and operators must be compensated for their time.

In addition to the time and cost, in vivo testing is not always reproducible and reliable. Rather, the test results are influenced by, for example, the cleansing motion of the operator (e.g., pressure, time, movement pattern, etc.) and the participant's skin (pigmentation, dryness, etc.). Even with a well-trained operator, these variables limit the ability to directly compare performance of cleansers between experiments/tests.

Thus, it can be appreciated that an in vitro screening system and method for evaluating the effectiveness of a cleanser for removing a challenge material on a substrate would be useful for supplementing and/or replacing the current in vivo testing.

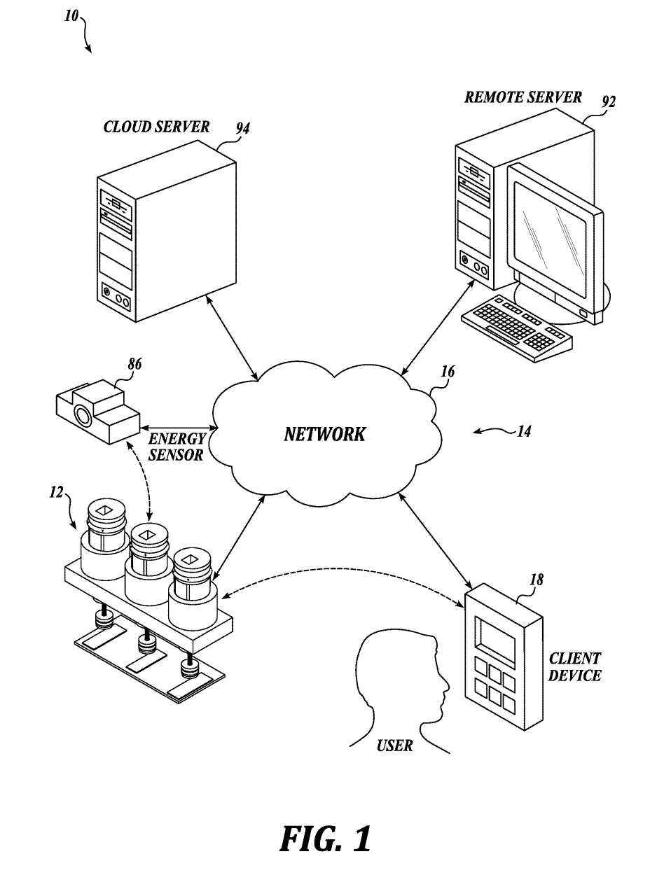

FIG. 1 depicts an exemplary pictorial depiction of an in vitro screening system 10 having a friction assembly 12 suitable for engaging and removing challenge material on a substrate and an analytics assembly 14 for generating cleanser-specific material removal information responsive to a detected response associated with the removal of the challenge material. In order to best understand aspects of the in vitro screening system 10, the friction assembly 12 will first be described in detail.

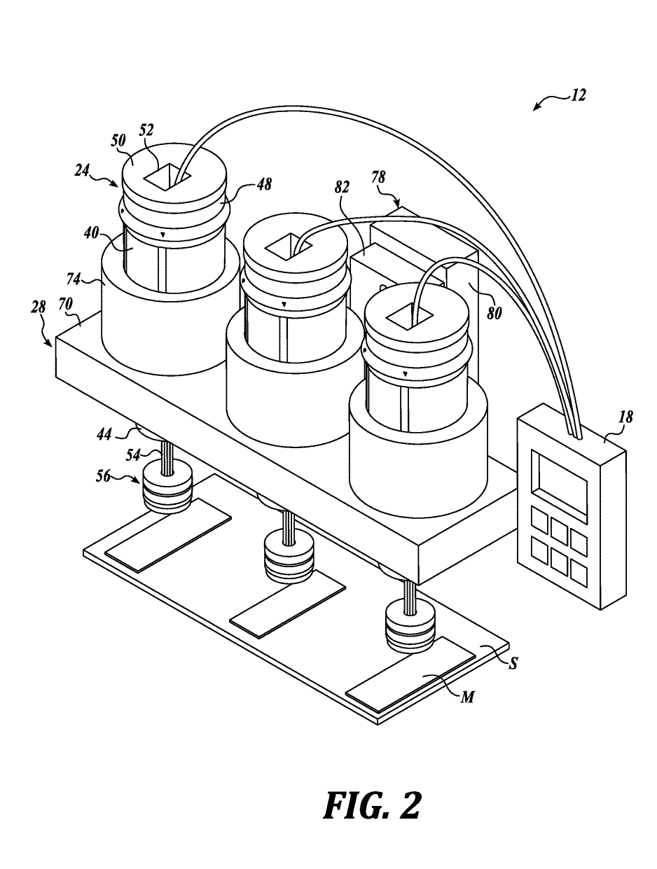

FIGS. 1 and 2 depict a first exemplary embodiment of a friction assembly 12 for use in the in vitro screening system 10. The friction assembly 12 is configured to engage and remove a challenge material from a substrate with a motorized friction structural component in a manner that mimics the manual gesture and feel of hand cleansing. In that regard, the friction assembly 12 generally includes at least one friction device 24 (and in the depicted embodiment, a plurality of friction devices 24) arranged in an array 28, with each friction device 24 configured to deliver motorized cleansing to a target area of a substrate S.

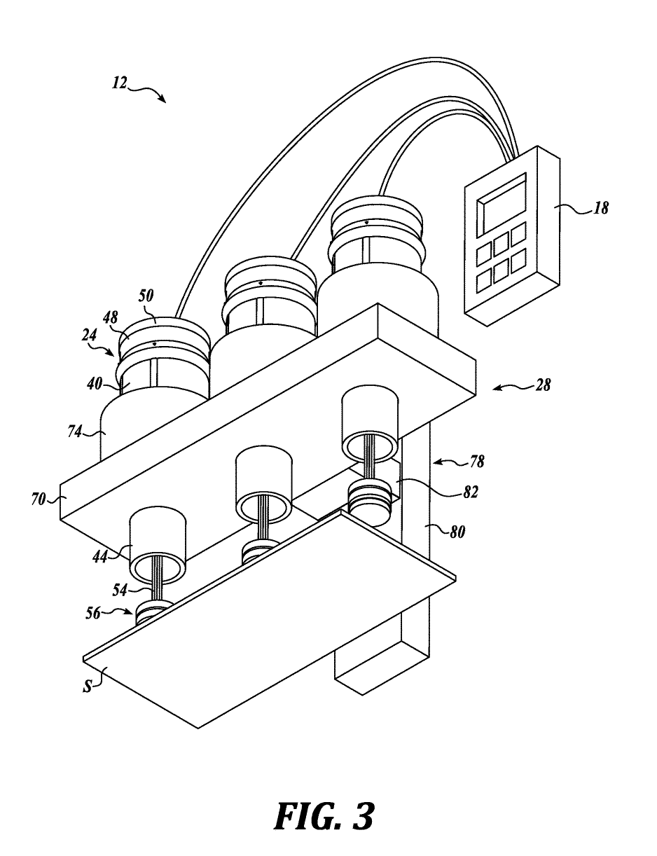

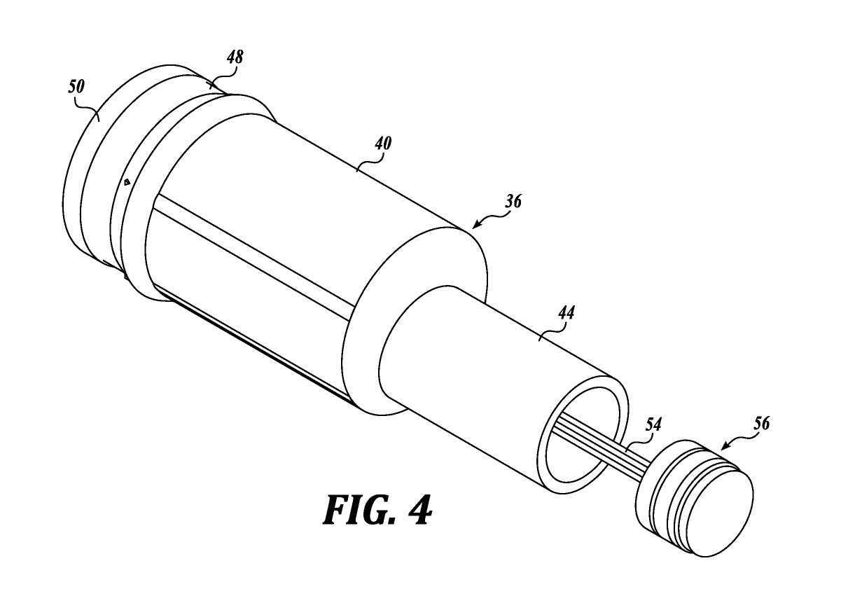

Referring to FIGS. 3 and 4, the friction device 24 will now be described in detail. The friction device 24 includes a device body 36 having a movement device enclosing portion 40 positioned axially between a shaft enclosing portion 44 and a cap receiving portion 48. Although the device body 36 and its subcomponents may be any suitable shape, in the depicted embodiment, the device body 36 is substantially cylindrical in shape, with the movement device enclosing portion 40 and the cap-receiving portion 48 being substantially the same cross-sectional diameter, and with the movement device enclosing portion 40 and the cap receiving portion 48 being larger in cross-sectional diameter than the shaft enclosing portion 44. The shaft enclosing portion 44 extends axially from a first end of the movement device enclosing portion 40, and the cap receiving portion 48 extends axially from a second opposite end of the movement device enclosing portion 40.

The cap receiving portion 48 is configured to receive a cap 50 for enclosing the second end of the movement device enclosing portion 40. The cap 50 may be secured to the cap receiving portion 48 in any suitable manner. For instance, the cap 50 may be secured within the cap-receiving portion 48 by friction fit, press fit, or otherwise. The cap 50 may include a suitable opening 52 for allowing the passage of electrical wires or other connection devices between an external power source, controller, etc., and the device 24. However, it should be appreciated that the device 24 may instead be controlled through wireless means and may have an internal power source, such as a rechargeable battery.

The movement device enclosing portion 40 is generally sized and shaped to house a suitable movement device (not shown) that is configured to move a driveshaft 54 extending therefrom in a predetermined movement pattern. For instance, the movement device may be a suitable electric motor configured to rotate the driveshaft 54 about its longitudinal axis at a predetermined speed. In one embodiment, the electric motor is a 45503 LEGO MINDSTORMS® Medium Servo Motor, which is a regular DC motor available from lego.com. However, other types of electric motors besides DC motors may be used, such as brushless induction motors or electric hub motors.

The desired movement pattern of the driveshaft 54 will depend on various factors, such as the intended use of the device, and if specifically used for evaluating the effectiveness of a cleanser for removing a challenge material deposited onto a substrate, how the movement will mimic the gesture and feel of hand cleansing. For instance, in some embodiments, the movement device may be an electric motor suitable to oscillate the driveshaft 54. In yet other embodiments, the movement device may be an electric motor suitable to move the driveshaft 54 in a random pattern. In yet other embodiments, the movement device may be an electric motor suitable to move the driveshaft 54 linearly along the axis of the driveshaft 54. In yet other embodiments, the movement device may be an electric motor suitable to move the driveshaft 54 in any one of the above-described fashions. As can be appreciated, the movement device may be anything suitably configured to move the driveshaft 54 in a desired manner. As noted above, the friction device 24, and specifically, the movement device may be powered and controlled by any suitable wired or wireless means.

The driveshaft 54, which extends from and is operably connected to the movement device, may be at least partially enclosed by the shaft enclosing portion 44, which extends axially from a second end of the movement device enclosing portion 40 (opposite the cap 50). The shaft enclosing portion 44 may be any suitable length to help protect the driveshaft 54, and it may be any suitable cross-sectional diameter to allow for the desired movement pattern of the driveshaft 54.

A distal end of the driveshaft 54 extends from the shaft-enclosing portion 44 and terminates in a friction structural component 56 that is configured to engage and apply friction to a substrate. In an exemplary embodiment, the friction structural component 56 is configured to engage and remove challenge material from a target area of a substrate when moved by the driveshaft 54. Any suitable friction structural component 56 may be used to produce a desired friction effect. For instance, in an exemplary embodiment, the friction structural component 56 is configured to engage and remove challenge material from a substrate in a way that mimics the feel of scrubbing with a fingertip and/or a cotton pad, wipe, etc.

In that regard, in the embodiment depicted, the friction structural component 56 includes a nub portion 60 configured to engage and remove challenge material from a substrate. The nub portion 60 may be made from a suitable material to mimic the feel of a fingertip, such as silicone, or a material similar to cotton or another material typically used in cleansing pads or wipes. In other embodiments in which the friction device 24 is used for other evaluation purposes, the nub portion 60 may be made from another suitable material, such as rubber, plastic, etc., or it may be another configuration, such as a brush head, a textured smoothing disc, an infusion tip, etc. The nub portion 60 is substantially cylindrical in shape and of a predetermined diameter to provide a desired friction effect on a substrate. As can be appreciated, in one embodiment, the diameter of the nub portion 60 may approximate an average fingertip that would be used by a user to cleanse a substrate, such as the face or another area of skin.

The nub portion 60 is disposed within or otherwise attached to a nub receptacle 64 by press fit or otherwise. The nub receptacle 64 mates with or attaches to a driveshaft connection portion 68 by a press fit connection or otherwise. At least a portion of the friction structural component 56 may be removable from the driveshaft 54 to allow for replacement of an old or used nub portion 60 and/or for interchanging the nub portion 60 with a different type of tip, such as a tip having a different material or configuration. For instance, in one exemplary embodiment, the nub portion 60 is permanently secured within the nub receptacle 64, and the nub receptacle 64 is removably secured to the driveshaft connection portion 68 to allow for interchangeability of the nub portion 60 and nub receptacle 64. In another exemplary embodiment, the nub portion 60 is removably secured within the nub receptacle 64, and the nub receptacle is either permanently or removable attached to the driveshaft connection portion 68. Any suitable assembly for removably connecting the nub portion 60 to the driveshaft 54 of the device 36 may instead be used. Moreover, it should be appreciated that in some embodiments, the friction structural component 56 is permanently secured to the driveshaft 54.

Referring back to FIGS. 1 and 2, and as noted above, a plurality of friction devices 24 may be arranged in an array 28 to define a friction assembly 12. In one embodiment, the array 28 is defined by an elongated, substantially planar platform 70 having a plurality of device receptacles 74 extending transversely therethrough. The device receptacles 74, which are spaced apart substantially evenly and are in substantial alignment along the length of the platform 70, are configured to removably receive and retain friction devices 24 therein.

With the friction devices 24 received within the platform 70, the platform 70 may be moved into an appropriate position for engaging the friction structural component 56 with a substrate S. In that regard, the platform 70 may be operably connected to and moveable by a platform movement assembly 78 (shown only partially in FIGS. 1 and 2). The platform movement assembly 78 may be any suitable automatic, semi-automatic, controllable, and/or manual assembly that is configured to move the platform 70, and therefore the array 28, vertically, horizontally, or in any other desired direction to appropriately position the friction structural component 56 relative to the substrate S.

For instance, the platform movement assembly 78 may include a base portion 80 configured to be mounted to a surface, such as a wall, desk, etc. The base portion 80 provides a fixed structure against which a platform mounting portion 82 may be moveably mounted. For instance, the platform mounting portion 82 may be moveable within one or more slots defined within the base portion 80 by manual or electronic means. The platform mounting portion 82 may be suitable connected to or may otherwise extend from the platform 70 such that the platform 70 (and therefore the array 28) moves with the platform mounting portion 82. The platform mounting portion 82 may be moveable between at least a first, non-cleansing position, wherein the platform 70 is at a height above the substrate S to position the friction structural component(s) 56 out of engagement with the substrate S, and a second, cleansing position, wherein the platform 70 is at a height above the substrate S to position the friction structural component(s) 56 in engagement with the substrate S.

The platform movement assembly 78 and the movement device of each of the plurality of friction devices 24 may be controlled by one or more suitable wired or wireless devices, such as a client device 18, or another computing device on a network 16 of the analytics assembly 14 (see FIG. 1). The client device 18 or other computing device includes suitable circuitry for controlling and for activating the platform movement assembly 78 to move the platform movement assembly 78 between at least the first, non-cleansing position and the second, cleansing position. In that regard, the precise location of the first, non-cleansing position and the second, cleansing position may be stored in memory of the client device 18 (or a remote computer on the network) for quick access through a designated button(s) or a software application or module.

The client device 18 or other computing device also includes suitable circuitry for controlling and activating the movement device to move the friction structural component 56 (through the driveshaft 54 or another mechanism) in a desired manner. In that regard, in one exemplary embodiment, the client device 18 may have input buttons that allow the user to interface with different applications or software modules to select different movement patterns, speeds, normal forces, amplitudes, sequences, etc., of the friction structural component 56. In another exemplary embodiment, the client device 18 may simply have an on/off switch for activating the movement device.

For instance, the movement device may be activated to move the friction structural component 56 with a specific applied normal force, a specific spinning, oscillating, and/or linear velocity, a specific amplitude or displacement magnitude, a specific movement pattern (about the axis of the driveshaft 54, in a circular motion, in an irregular pattern, etc.), or with any other suitable movement or force. In addition or in the alternative, the movement device may be activated to move the friction structural component 56 in temporally spaced-apart sequences. For instance, the movement device may be activated at various points in time during the screening process to acquire various cleanser-specific material removal information data points (e.g, first rub with the friction structural component 56, then assess cleanser capability, then rub again with the friction structural component 56, and then assess cleanser capability again).

It should be appreciated that the client device 18 may be configured to control any aspect of the movement device and/or the platform movement assembly 78 and/or other aspects of the in vitro screening system 10. Moreover, the client device 18 may be connected to the movement device and/or the platform movement assembly 78 through wired or wireless means. In the depicted embodiment, the client device 18 is shown connected to the movement devices of each friction device 24 through a wire. However, in another exemplary embodiment, the client device 18 may be configured as a wirelessly connected device, such as a smart phone or a tablet.

As noted above with reference to FIG. 1, one embodiment of an in vitro screening system 10 includes an analytics assembly 14 for detecting a response associated with the removal of the challenge material by the cleanser and friction assembly 12 and generating cleanser-specific material removal information responsive to a detected response associated with the removal of the challenge material. The phrase “cleanser-specific material removal information” or the like may be understood to include information relevant for assessing cleanser capability or efficacy, such as intensity change of a target area, a percentage of material removed, a percentage cleansed, a material removal score, an efficacy factor, etc. The cleanser-specific material removal information is generated in response to a detected response associated with the removal of challenge material, such as a detected electromagnetic response of a target area with challenge material applied compared to a detected electromagnetic response of a target area with challenge material removed with the cleanser and friction assembly 12.

In that regard, the analytics assembly 14 includes an energy sensor 88 suitably configured to detect an electromagnetic energy response associated with removal of challenge material from a substrate by the cleanser and friction assembly 12. In one exemplary embodiment, the energy sensor 88 includes a rigged camera system configured to detect the color difference on the substrate before and after the challenge material is removed from the substrate by the cleanser and friction assembly 12. The rigged camera system may include a high-resolution digital single-lens reflex (DSLR) camera that may be positioned over the substrate before and after the challenge material is removed by the friction assembly 12 to capture an image. Images may be taken of the untreated (without challenge material), treated (with challenge material), and cleansed target areas of the substrate and normalized (e.g., each image may be calibrated with a color checker chart to mitigate lighting disparities and variances in flash intensity), and the lightness value (L-value) before and after cleansing with the cleanser and friction assembly 12 may be calculated by a suitable computing device of the analytics assembly 14 using software programs well known in the art, such as MATLAB. The L-value difference in a target area before and after cleansing can be analyzed to indirectly determine the amount of challenge material removed.

In addition to or in lieu of the rigged camera system, the energy sensor 88 may further include a measurement instrument designed to evaluate the color of objects, such as a chroma meter, a colorimeter, a color reader, etc. In one exemplary embodiment, a CR-400 Chroma Meter available from Konica Minolta may be used. Using a chroma meter, the energy sensor 88 can use a defined light source (such as D65) to illuminate a target area of a substrate before challenge material is applied, with the challenged material deposited onto the target area, and after challenge material is removed from the target area of the substrate. When illuminated, the chroma meter can capture spectral data in L*a*b color space, as well known in the art. The variance in L-values before challenge material is applied, with the challenged material deposited onto the target area, and after challenge material is removed from the target area of the substrate may be calculated by a suitable computing device of the analytics assembly 14 using software programs well known in the art. The L-value difference in a target area before and after cleansing can be analyzed to indirectly determine the amount of challenge material removed. It should be appreciated that any other suitable sensor(s) may be used to detect an electromagnetic response of the target area of the substrate.

As noted above, the analytics assembly 14 generates cleanser-specific material removal information in response to the detected electromagnetic response by the energy sensor 88. In that regard, the analytics assembly 14 may include circuitry (on the client device 18 or on another suitable computer on the network 16) configured to generate intensity change information of a target area of a substrate based on comparing at least a first detected electromagnetic response to a second detected electromagnetic response. The first detected electromagnetic response of the target area may be captured with a chroma meter, for instance, before the challenge material is applied to the target area of substrate, and the second detected electromagnetic response of the target area may be captured after the challenge material is removed by the cleanser and friction assembly 12. A comparison of the first detected electromagnetic response to the second detected electromagnetic response may be used to indicate the efficacy or cleansing capability of the cleanser.

In another exemplary embodiment, the analytics assembly 14 may include circuitry (on the client device 18 or on another suitable computer on the network 16) configured to generate cleanser-specific material removal information based on comparing at least a first image to a second image. For instance, a first image of a target area of a substrate may be captured with the rigged camera system before challenge material is applied, and a second image of a target area of a substrate may be captured after the challenge material is removed by the cleanser and friction assembly 12. A comparison of the first image to the second image may be used to indicate the efficacy or cleansing capability of the cleanser.

In one exemplary embodiment, the cleanser-specific material removal information of the target area is calculated as the percentage cleansed (% Cleansed) with the following formula:

$$\% Cleansed = \frac{{I}_{cleansed} - {I}_{CM}}{{I}_{bare} - {I}_{CM}} \times 100$$

In the above formula, I_{cleansed} represents the intensity of the target area after being cleansed by the cleanser and friction assembly 12, I_{bare} represents the intensity of the target area before challenge material is applied to the target area, and I_{CM} represents the intensity of the target area after the challenge material is applied. An ideal cleanser having 100% cleansing capability is observed when the intensity of target area after cleansing with the cleanser and friction assembly 12 (I_{cleansed}) is equal to the intensity of the target area before the challenge material is applied (I_{bare}).

The analytics assembly 14 may include any suitable combination of sensors, devices, computers, etc., for generating cleanser-specific material removal information in response to detected electromagnetic responses. In that regard, FIG. 1, as briefly described above, depicts an exemplary pictorial depiction of an analytics assembly 14 in communication with the friction assembly 12 to collectively define an in vitro screening system 10. It should be appreciated that the analytics assembly 14 hereinafter described is provided for illustrative purposes only. Moreover, although specific system configurations are illustrated, it should be understood that examples provided herein are not exhaustive and do not limit the present disclosure to the precise forms disclosed. Persons having ordinary skill in the field of computers will recognize that components described herein may be interchangeable with other components or combinations of components and still achieve the benefits and advantages of the disclosed in vitro screening system and the method for in vitro evaluation of the cleansing capability of a cleanser for removing challenge material on a substrate. Furthermore, the computer components hereinafter described may be grouped in a single location or distributed over a wide area.

Other potential methods for capturing cleanser-specific material removal information could include:
1. Adding a fluorophore to the challenge material such that the challenge material fluoresces under relevant light. Spectral data of the substrate captured before and after cleansing could provide qualitative insight as to how much challenge material was removed by the cleanser.
2. Capturing a thickness profile over the target area would provide a straightforward metric of how many layers of challenge material were removed during the cleansing process.
3. Capturing the index of refraction as light propagates through the challenge material before and after cleansing could be an indirect measure of the remaining thickness of the challenge material film on the substrate. This refractive index sensing could potentially be done using a surface plasmon sensor.

In the exemplary embodiment, the analytics assembly 14 includes at least one of a client device 18, a remote network or server 92, and a cloud server 94 in communication with a network 16 and/or the friction assembly 12. In the depicted embodiment, the client device 18 is also shown associated with a user. The cloud server 94 and the remote server 92 are configured to communicate with each other and with the client device 18 via the network 16, which may be implemented as a local area network (“LAN”), a wide area network (“WAN”), or the global network commonly known as the Internet. As known to those skilled in the art and others, the computers 92 and 94 and the client device 18 illustrated in FIG. 1 may be configured to exchange (optionally encrypted and anonymized) files, commands, and other types of data or information over the network 16. However, since protocols for network communication such as TCP/IP are well known to those skilled in the art of computer networks, those protocols will not be described herein.

The functions performed by each of the computers described with reference to FIG. 1 may instead be implemented by a plurality of computers. For example, while the cloud server 94 is illustrated as a single computer, single-based functionality is frequently handled in a “server farm” in which multiple servers cooperate in executing necessary tasks so that requests from potentially large numbers of users may be satisfied. Moreover, in addition to the conventional computer systems illustrated in FIG. 1, those skilled will recognize that the present method may be practiced on other kinds of computers, including laptop computers, tablet computers, personal digital assistants (“PDAs”), or any other suitable device in which computer software or other digital content may be executed.

In the context of FIG. 1, the cloud server 94 may be configured to generate and store in vitro screening programs and files for upload and use on the client device 18. The in vitro screening programs and files may be accessible by uploading programs and/or files from the cloud server 94, by accessing programs/files through a shared library, or through a Web-based program accessible on the remote server 92.

The remote server 92 may include suitable programs for accessing the in vitro screening programs and files from the cloud server 94 over the network 16. An operator may access the in vitro screening programs and files on the remote server 92 to retrieve, modify, and/or build customized in vitro screening programs and files for downloading onto the client device 18. It should be appreciated that the in vitro screening programs and files may instead be stored locally on the remote server 92 as well as any modified or customized in vitro screening programs and files, for uploading and use on the client device 18.

The client device 18, briefly described above, may include suitable hardware and firmware for uploading the in vitro screening programs and files onto the client device 18. The client device 18 may be placed into communication with the remote server 92 though a serial or RS 232 port, a USB connection, or other wired means, through a wireless connection, or by other suitable means. In the alternative, the client device 18 may simply be placed into wireless communication with the cloud server 94. The client device 18 may also include suitable hardware and firmware for running the in vitro screening programs and files on the client device 18, and thereafter uploading the completed/modified in vitro evaluation file onto the remote server 92 or cloud server 94 for archive and storage. The completed in vitro evaluation file may either be stored locally on the remote server 92, or instead stored on the cloud server 94.

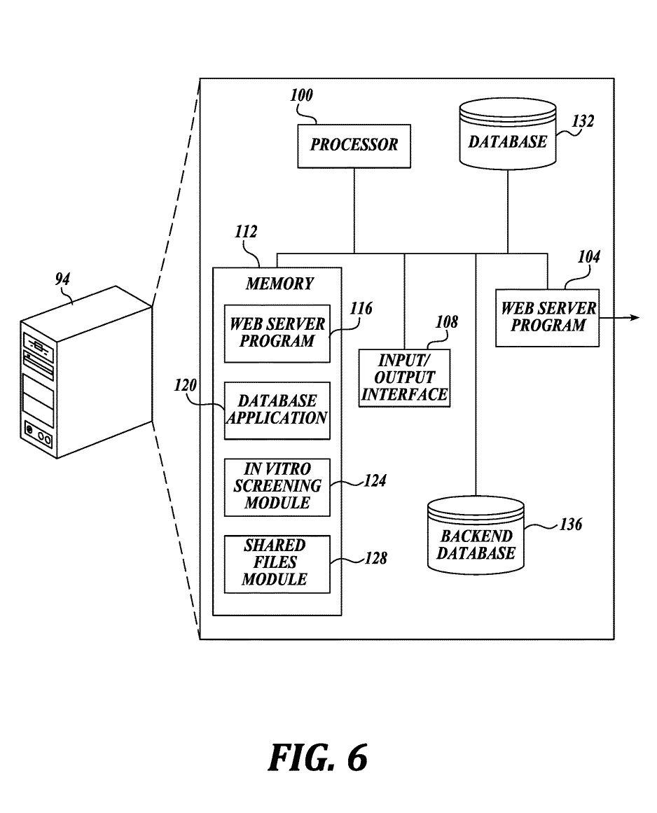

Referring to FIG. 6, an exemplary architecture of the cloud server 94 depicted in FIG. 1 that illustrates computer components suitable to implement aspects of the in vitro screening system 10 and the method for in vitro evaluation of the cleansing capability of a cleanser for removing challenge material on a substrate will be described. Those skilled in the art and others will recognize that the cloud server 94 illustrated in FIG. 1 may be any one of a variety of devices, including, but not limited to, personal computing devices, server-based computing devices, mini and mainframe computers, laptops, or other electronic devices having some type of memory. In the embodiment illustrated in FIG. 6, the cloud server 94 includes a processor 100 in communication with a variety of computing elements, including a network interface 104, an input/output interface 108, and a memory 112.

The network interface 104 depicted in FIG. 6 enables the cloud server 94 to communicate data, control signals, requests, and other information via a communication network (LAN, WAN, Internet, etc.) such as the network 16 described above with respect to FIG. 1. For instance, the cloud server 94 may receive requests from other networked computers and transmit data back to a requesting computer using the network interface 104.

The input/output interface 108 enables the cloud server 94 to communicate with various local input and output devices. An input device in communication with the input/output interface 108 may include computing elements that provide input signals to the cloud server 94, such as a keyboard, mouse, external memory, disc drive, blue tooth device, etc. Also, an output device in communication with the input/output interface 108 may include computing elements that accept output signals such as a monitor, a printer, and the like.

The processor 34 is configured to operate in accordance with computer program instructions stored in a memory, such as the memory 112. In some computing systems, program instructions may also be embodied in a hardware format, such as a programmed digital signal processor. In any event, as illustrated in FIG. 6, the memory 112 stores a Web server program 116, a database application 120, an in vitro screening module 124, and a shared files module 128.

The Web server program 116 illustrated in FIG. 6 comprises computer-executable instructions that, when executed by the processor 100, generates configurable markup documents (hereinafter referred to as “Web pages”). The Web server program 116 provides a way for the cloud server 94 to interact with users of other network-accessible computers. For example, the Web server program 116 is configured to generate Web pages and cause markup code form Web pages to be accessible from the network 16. When a Web page is accessed, the Web server program 116 may receive data back from a network computer that describes the user's interactions with the Web page. In accordance with one embodiment of the presently disclosed method, the content of the Web pages generated by the Web server program 116 serve as an interface that enables users to create, modify, and access in vitro screening programs and files for downloading onto the client device 18 or another computer. Moreover, the content of the Web pages generated by the Web server program 116 serve as an interface that enable users to upload data to a database 132, and access any stored data within the database 132 and/or a back end database 136.

The Web server program 116 also interacts with other computer components illustrated in FIG. 6 so that the appropriate data may be obtained from or communicated to a user. For example, a request to create a customized in vitro screening program may be received form a user. In this instance, data associated with the request is received at the Web server program 116 and it is forwarded to the in vitro screening module 124 so that the in vitro screening module 124 may be run to create a customized in vitro screening program.

In another instance, a request to upload a completed in vitro screening program file from the client device 18 (optionally through the remote server 92) may be received from a user. In such an example, data associated with the request is received at the Web server program 116 and forwarded to the database application 120 so that the database 132 may be updated. In that regard, when a request to retrieve completed in vitro evaluation data or a customized in vitro screening program is received from a user, the data associated with the request is received at the Web server program 116 and forwarded to the database application 120 so that the database 132 may retrieve the data or file. As can be appreciated from the foregoing, the database application 120 provides mechanisms for updating and/or retrieving data stored in the database 132 such that a user may retrieve or upload data associated with a corresponding in vitro screening program or file through an in vitro evaluation Web site. The database application 120 may also be suitable for authenticating the user and/or electronic signature such that archived data may only be retrieved by authorized personnel.

The Web server program 116 may also interact with the database application 120 to retrieve data from the back end database 136 that stores data necessary to provide Web pages for enabling users to create and access in vitro screening programs and files, for enabling users to upload data associated with completed in vitro screening files, and for enabling users to retrieve data from previously stored completed in vitro screening files. It should be appreciated that the database 132 and back end database 136 may instead be combined into one database, or instead, additional databases may be used.

In addition or as an alternative to the Web server program 116, a shared files module 128 may be included for providing remote access to the in vitro screening programs and files created by the in vitro screening module. The shared files module 128 could be configured as a Dynamic Link Library (DLL) or any other suitable configuration to provide an interface on the remote server 92 for downloading and retrieving files on the client device 18.

As noted above, the in vitro screening programs and files may alternatively be stored locally on the remote server 92. In that regard, the remote server 92 may communicate directly with the client device 18 through wired or wireless means without the use of a network. In this alternative embodiment, the remote server 92 may include computer components similar to those of the cloud server 94 described above with respect to FIG. 6. For instance, the in vitro screening module 124 would be stored locally on the remote server 92 for creating customized in vitro screening programs and files, accessing created in vitro screening programs and files, modifying in vitro screening programs and files, etc. Moreover, the database application 120 would be configured to store and retrieve in vitro screening data locally in the database 132 and/or the backend database 70.

The in vitro screening programs and files may comprise any suitable instructions for activating and controlling the friction assembly 12. For instance, the in vitro screening programs and files may comprise suitable instructions for varying at least one of a friction structural component applied normal force, a friction structural component velocity, and a friction structural component amplitude of the friction assembly 12. Furthermore, the in vitro screening programs and files may comprise suitable instructions for varying the movement pattern of the frictional structural component 56, the temporal sequences of the frictional structural component 56, or other aspects of the friction assembly 12.

The in vitro screening programs and files may also comprise suitable instructions for generating cleanser-specific material removal information responsive to a detected response associated with the removal of challenge material on a substrate by the cleanser and friction assembly 12. For instance, the in vitro screening programs and files may comprise suitable instructions for processing an electromagnetic energy response of a target area of a substrate when detected by the energy sensor 88 or the like. In that regard, the in vitro screening programs and files may comprise suitable instructions for comparing a first electromagnetic energy response of a target area to a second electromagnetic energy response of the target area, and generating intensity change information, such as the percentage cleansed, to determine cleansing capability information for the cleanser. The in vitro screening programs and files may also comprise suitable instructions for comparing a first image of a target area to a second image of the target area, and generating intensity change information, such as the percentage cleansed, to determine cleansing capability information for the cleanser.

One exemplary embodiment of the method and operation of the in vitro screening system 10 will now be briefly described, noting that detailed aspects of the system and its operation are set forth above. Referring to FIG. 2, with the friction devices 24 arranged in the array 28, the friction assembly 12 may be used to evaluate the efficacy of a cleanser, such as a cleanser for removing a challenge material M on a substrate S. It should be appreciated that more or less than three in vitro evaluation devices 24 may be arranged in the array 28 during use. Moreover, it should be appreciated that an individual friction device 24 may be used apart from the array 28 in a similar manner.

To prepare the friction assembly 12, each friction device 24 is disposed within a device receptacle 74 of the platform 70 such that the friction structural component 56 protrudes from a bottom of the platform 70 (if the friction devices 24 are not already permanently disposed within the device receptacles 74). A substrate S having a challenge material M deposited thereon is positioned below the friction assembly 12. In the specific embodiment shown in FIGS. 1 and 2, the substrate S includes first, second, and third areas of challenge material M (only one area labeled), with each area of challenge material M positioned beneath a corresponding friction structural component 56 of an friction device 24. The array 28 may be moved horizontally either manually or with the platform movement assembly 78 to ensure alignment of the challenge material M and the corresponding friction structural component 56.

After the challenge material M is suitably deposited (and optionally cured) on the substrate S, a test cleanser may be applied to an area of challenge material M and/or the corresponding friction structural component 56 of a friction device 24. With the cleanser applied to at least one of the friction structural component 56 and the area of challenge material M, the array 28 may be moved vertically toward the substrate S by the platform movement assembly 78 to engage the friction structural component 56 with the corresponding area of challenge material M on the substrate S.

Once appropriately positioned relative to the substrate S, the movement device of each friction device 24 may be activated by the controller 90 to move the driveshaft 54 and the friction structural component 56. In one specific embodiment, the movement device is activated to rotate the friction structural component 56 at a predetermine velocity about the longitudinal axis of the driveshaft 54 such that the nub portion 60 of each friction structural component 56 may scrub against the challenge material M deposited onto the substrate S. The friction structural component 56 scrubs the area of challenge material M on the substrate S for a predetermined amount of time or for a predetermined number of temporal sequences to test the efficacy of the cleanser for removing the challenge material M from the substrate S.

It can be appreciated that each friction device 24 may be used to test a different cleanser on a predetermined challenge material. In the alternative, each friction device 24 may be used to test one cleanser on various challenge materials. The in vitro evaluation devices 24 may be arranged in an array as desired to test a desired number of cleansers and/or challenge materials. In other words, the friction assembly 12 is scalable to accommodate different testing needs.

The energy sensor 86 may be used to detect electromagnetic responses of each target area before the challenge material M is applied, after the challenge material M is applied, and after the challenge material M is removed (at least partially) by the cleanser and corresponding friction structural component 56. The detected electromagnetic responses can then be processed by suitable circuitry of the analytics assembly 14, such as the in vitro screening module 124, to generate cleanser-specific material removal information responsive to the detected electromagnetic responses. The control information associated with the operation of the friction assembly 12 and the resulting cleanser-specific material removal information responsive to the detected electromagnetic responses may be exchanged between computing devices in the analytics assembly 14, and/or stored within the database of one of the computing devices for later retrieval.

One of ordinary skill can appreciate that the in vitro screening system 10 (or even a friction device 24 individually) saves significant time and resources that are otherwise consumed with in vivo testing. In that regard, aspects of the in vitro screening system 10 may be used to replace some or all of the in vivo testing that is typically done to evaluate the efficacy of a cleanser for removing a challenge material from a substrate. In the alternative or in addition thereto, the in vitro screening system 10 may be used for a pre-screening step for identifying which cleansers are worthwhile for additional in vivo testing.

A number of tests were performed to compare prior art in vivo testing (with the use of fingertips) to in vitro testing using a friction device 24 of the in vitro screening system 10. Specifically, comparative tests were performed to determine if the efficacy of a cleanser for removing a challenge material from a substrate may be evaluated using an in vitro evaluation device with the same level of reliability and reproducibility as the prior art in vivo testing. These test results are included below in EXPERIMENTS 1 and 2.

The inventors have found that a friction device 24 as described and illustrated in the present disclosure produces very comparable results to the prior art in vivo testing.

### Experiment 1—In Vivo Evaluation

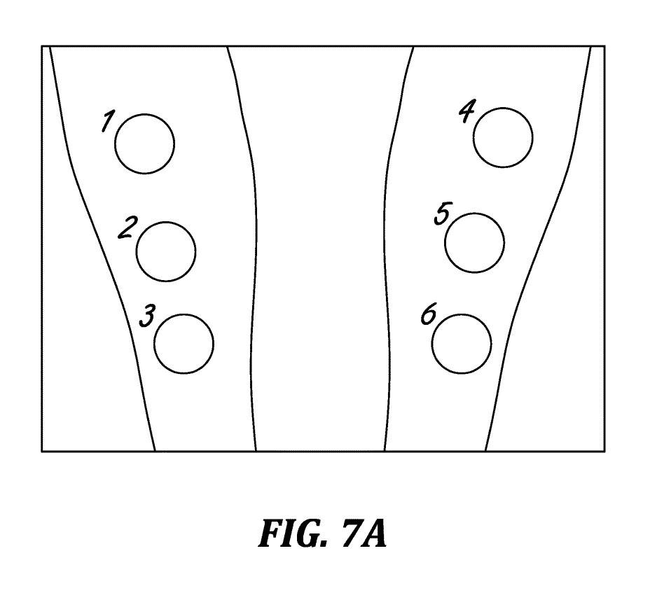

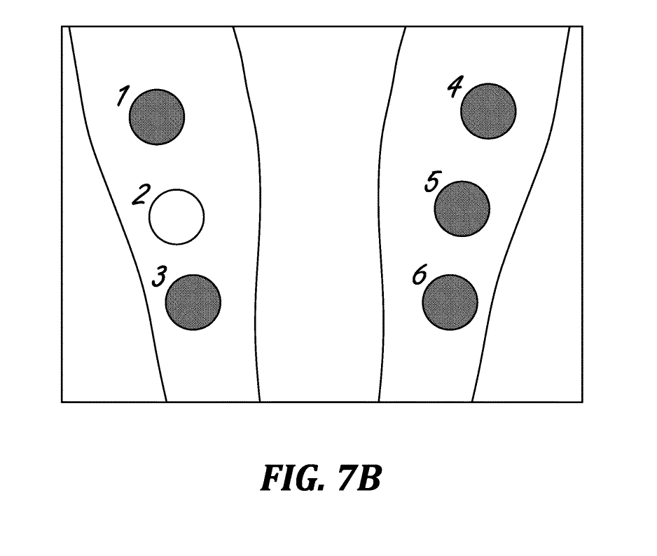

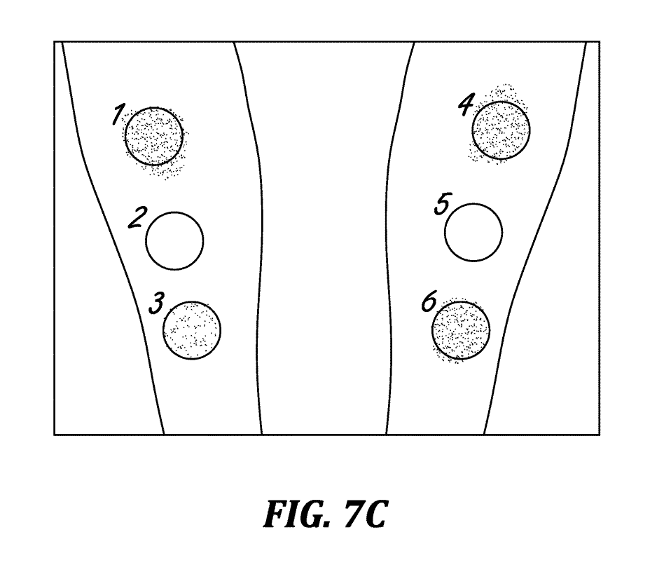

The purpose of this experiment was to set a baseline from which an evaluation using a friction device 24 of the in vitro screening system 10 may be compared. In this baseline experiment, a prior art in vivo evaluation was conducted to determine the efficacy of a cleanser for removing a challenge material from a substrate. The study included 14 participants. The cleanser studied was Bi-Facil makeup remover from Lancome of Paris, and the challenge material applied (as shown in FIGS. 7A and &B) was an opaque sebum and pollutant particle mix, such as Sebollution, a synthetic sebum mixture as described in U.S. Patent Application Publication No. 20150177221, herein incorporated by reference in its entirety.). Upon removing the challenge material with a cleanser, as shown in FIG. 7C, a NIKON DSLR camera along with a standardized color card were used to capture image-based L*a*b* color information under controlled lighting conditions.

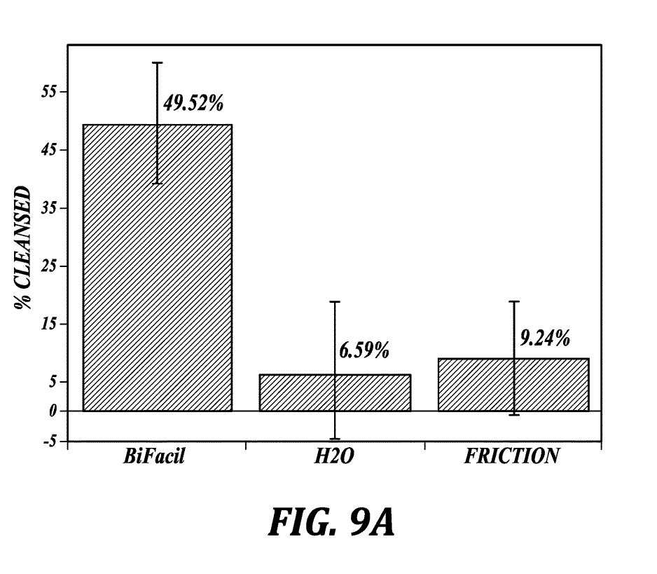

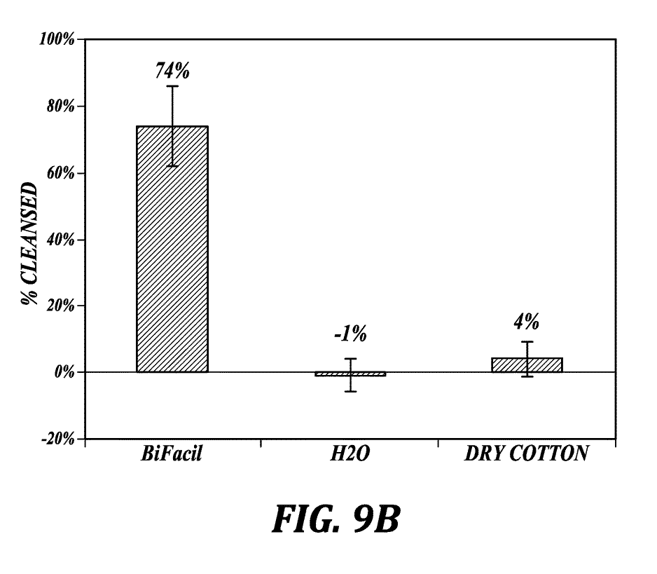

The results of the study (percentage cleansed) are graphically depicted in FIG. 9B.

### Experiment 2—In Vitro Evaluation

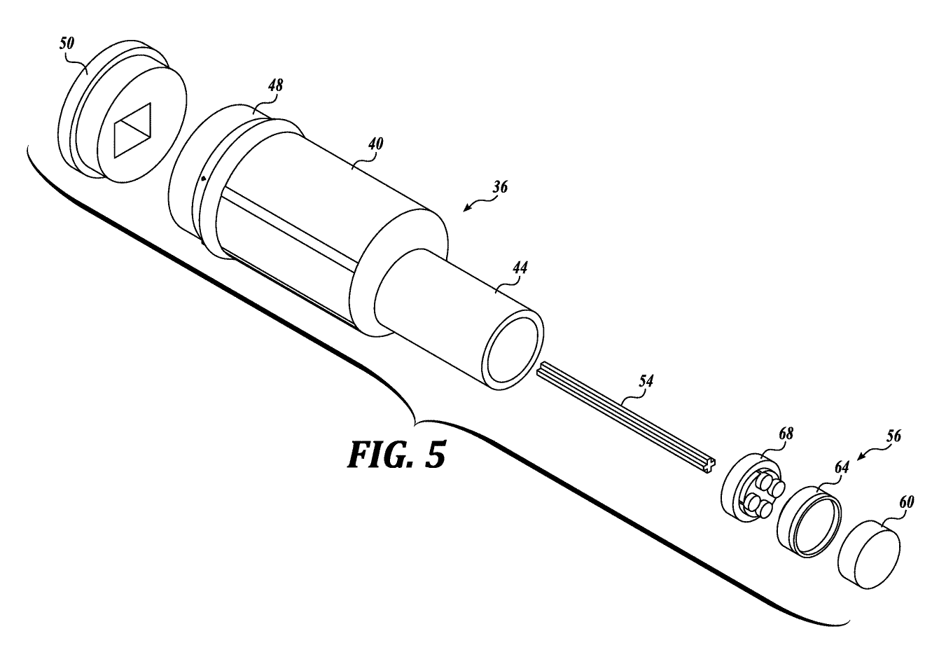

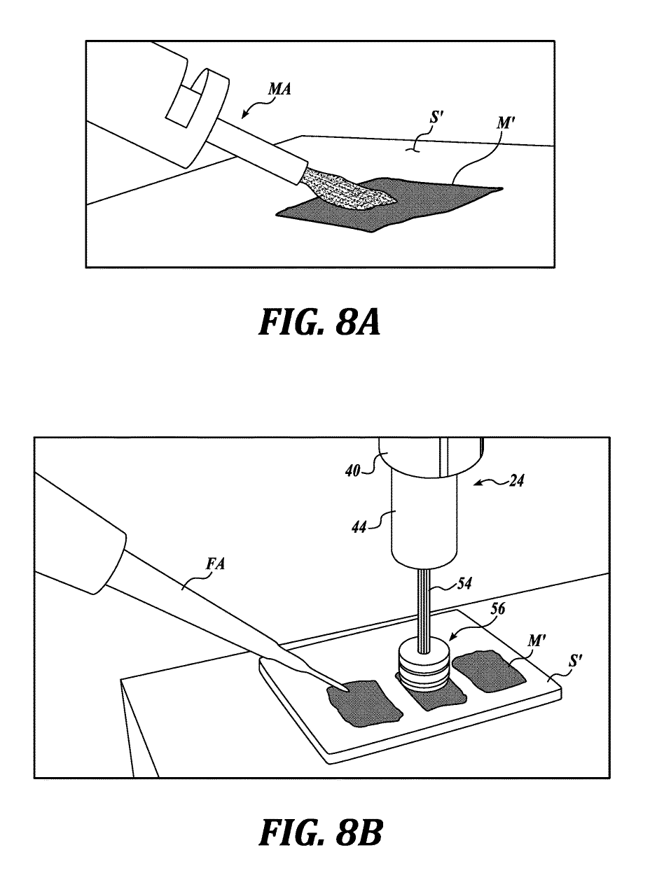

The purpose of this experiment was to determine whether a friction device 24 of the in vitro screening system 10 produced comparable results to the prior art in vivo evaluation method used in EXPERIMENT 1. The study included 8 total trials (2 separate runs of 4 trials each). The cleanser studied was Bi-Facial makeup remover from Lancome of Paris, the substrate was BioSkin, and the challenge material was makeup comprising long wear lipstick. A NIKON DSLR camera along with a standardized color card were used to capture image-based L*a*b* color information under controlled lighting conditions. The procedure for the study included the following:
1. A pre-baseline (bare skin) image was captured of each of several target areas of the substrate.
2. Referring to FIG. 8A, 0.025 mL of makeup was applied to and spread evenly within each target area with a brush applicator. A baseline (with makeup added) image was captured of each target area.
3. With a syringe, 0.25 mL or 0.25 g of the Bi-Facil cleanser (3:1 water to cleanser) was dispensed onto each target area of the substrate.
4. The Bi-Facil cleanser was rubbed onto the target areas using a friction assembly similar to that shown and described above with reference to FIGS. 4 and 5 with consistent pressure and time, with the tip assembly rotating about the axis of the driveshaft. The cleansing resulted in at least a partial removal of the makeup. Certain areas were cleansed with only water or with only the friction of the tip assembly (i.e., no water or cleanser).
5. Images were captured of the target areas after cleansing with a cross polarized camera setup. Target areas were in similar position within field of view as in the pre-baseline (no makeup), baseline (with makeup added) and T1 (after cleansing).
6. The % makeup cleansed was calculated based on the changes in intensity between the bare skin image, the challenge material image, and the cleansed image.

The procedure may also optionally include a rinsing, blotting or drying step before the makeup is applied and/or after the target area is cleansed, or before or after any other suitable step in the procedure. The results of the study (percentage cleansed) are graphically depicted in FIG. 9A.

As can be appreciated by comparing FIG. 9A to FIG. 9B, the cleanser capability results (percentage cleansed) produced using the friction device 24 of the in vitro screening system 10 are similar to the results produced using the prior art in vivo method. Accordingly, the in vitro screening system 10 and method for evaluating the effectiveness of a cleanser for removing a challenge material on a substrate is useful for supplementing and/or replacing the prior art in vivo testing.

Moreover, the variability is reduced by using the in vitro screening system 10 and method for evaluating the effectiveness of a cleanser for removing a challenge material on a substrate in comparison to the in vivo method. Specifically, the cleansing motion of the friction assembly 12 is identical for each procedure, in comparison to the variability in an operator's cleansing motion (e.g., pressure, time, movement pattern, etc.) between procedures. Moreover, identical artificial substrates may be used with each procedure of the in vitro method, compared to using a participant's skin, which varies in pigmentation, dryness, etc., between procedures. Variability between participant populations and in participant's skin over time can make direct comparisons of cleanser performance between procedures more difficult using the in vivo method.

With reduced variability in the in vitro system and method, the required “n” or number of repetitions for evaluating a cleanser is reduced. More specifically, the higher variability in an in vivo procedure requires the enrollment of a larger number of participants, especially if the cleansers tested are close in performance. The in vitro screening system 10 and method increases cleanser performance predictability from one procedure to another, thereby enabling reliable comparison of cleanser performance between procedures.

The detailed description set forth above in connection with the appended drawings is intended as a description of exemplary embodiments of the in vitro screening system and method for evaluating the effectiveness of a cleanser and are not intended to represent the only embodiments. The representative embodiments described in this disclosure are provided merely as an example or illustration and are not intended to be exhaustive or to limit the claimed subject matter to the precise forms disclosed.

Moreover, although the friction assembly 12 has been mostly described as being used for in vitro evaluation of the efficacy of a cleanser for removing a challenge material from a substrate, the friction assembly 12 may instead be used for any other suitable evaluation.

In the foregoing description, numerous specific details are set forth in order to provide a thorough understanding of the exemplary embodiments of the present disclosure. It will be apparent to one skilled in the art, however, that the exemplary embodiments of the present disclosure may be practiced without some or all of the specific details. In some instances, well-known process steps or features have not been described in detail in order not to unnecessarily obscure various aspects of the present disclosure. Further, it will be appreciated that the exemplary embodiments of the present disclosure may employ any combination of features described herein.

The present disclosure may also include references to directions, such as “forward,” “rearward,” “front,” “back,” “upward,” “downward,” “lateral,” “medial,” “in,” “out,” “extended,” “advanced,” “retracted,” “vertical,” “horizontal,” “proximal,” “distal,” “central,” etc. These references, and other similar references in the present disclosure, are only to assist in helping describe and understand the particular embodiment and are not intended to limit the present disclosure to these directions or locations.

The present disclosure may also reference quantities and numbers. Unless specifically stated, such quantities and numbers are not to be considered restrictive, but exemplary of the possible quantities or numbers associated with the present disclosure. Also in this regard, the present disclosure may use the term “plurality” to reference a quantity or number. In this regard, the term “plurality” is meant to be any number that is more than one, for example, two, three, four, five, etc. In an embodiment, “about,” “approximately,” etc., means plus or minus 5% of the stated value.

Thus, while illustrative embodiments have been illustrated and described, it will be appreciated that various changes can be made therein without departing from the spirit and scope of the invention.

The embodiments of the invention in which an exclusive property or privilege is claimed are defined as follows:

1. An in vitro screening system, comprising:
a friction assembly including at least one motorized friction structural component configured to engage and remove material on a substrate; and
an analytics assembly including at least one sensor and circuitry configured to generate cleanser-specific material removal information responsive to a detected response associated with removal of a material on a substrate by the friction structural component.

2. The in vitro screening system of claim 1, wherein the detected response is an electromagnetic response.

3. The in vitro screening system of claim 1, further comprising circuitry configured to vary at least one of a friction structural component applied normal force, a friction structural component velocity, and a friction structural component amplitude.

4. The in vitro screening system of claim 1, further comprising circuitry configured to exchange screening system control information with at least one of a remote network, a client device, and a cloud server.

5. The in vitro screening system of claim 1, further comprising circuitry configured to exchange at least one of screening system control information, friction structural component applied normal force information, friction structural component velocity information, and friction structural component amplitude information with at least one of a remote network, client device, and a cloud server.

6. The in vitro screening system of claim 1, further comprising circuitry configured to exchange cleanser-specific material removal information with a remote network, client device, or cloud server.

7. The in vitro screening system of claim 1, further comprising circuitry configured to exchange encrypted and anonymized screening system control information with at least one of a remote network, client device, and a cloud server.

8. The in vitro screening system of claim 1, further comprising circuitry configured to exchange encrypted and anonymized cleanser-specific material removal information with at least one of a remote network, client device, and a cloud server.

9. The in vitro screening system of claim 1, wherein the analytics assembly includes circuitry configured to generate cleanser-specific material removal information based on comparing a first image to a reference image.

10. The in vitro screening system of claim 1, wherein the analytics assembly includes circuitry configured to generate cleanser-specific material removal information based on comparing a detected electromagnetic response to reference electromagnetic response information.

11. The in vitro screening system of claim 1, wherein the friction structural component includes a tip extending from a device body, the tip moveable in a preselected manner for engaging the substrate.

12. The assembly of claim 1, wherein the tip is a silicone tip.

13. The assembly of claim 1, wherein the friction assembly includes a plurality of motorized friction structural components arranged within a moveable array.

14. A method of evaluating the cleansing capability of a cleanser for removing a challenge material on a target area of a substrate, the method comprising:
delivering a motorized rubbing motion to the target area of the substrate including a challenge material with a motorized friction structural component; and
generating cleanser-specific material removal information responsive to detecting a plurality of electromagnetic responses associated with delivering the motorized rubbing motion to the target area of the substrate including the challenge material.

15. The method of claim 14, further comprising generating time series cleanser-specific material removal information responsive to detecting a plurality of electromagnetic responses associated with temporally spaced-apart sequences of delivering the motorized rubbing motion to the target area of the substrate including the challenge material.

16. The method of claim 15, wherein generating the time series cleanser-specific material removal information includes generating cleanser-specific material removal information based on comparing one or more detected electromagnetic responses of the target area of the substrate to reference electromagnetic response information.

17. The method of claim 14, wherein generating the cleanser-specific material removal information includes comparing one or more detected electromagnetic responses of the target area of the substrate to reference electromagnetic response information.

18. The method of claim 14, further comprising exchanging cleanser-specific material removal information with at least one of a remote network, a client device, and a cloud server.

19. The method of claim 14, further comprising varying at least one of a friction structural component applied normal force, a friction structural component velocity, and a friction structural component amplitude.

20. The method of claim 14, further comprising exchanging at least one of friction structural component control information, friction structural component applied normal force information, friction structural component velocity information, and friction structural component amplitude information with at least one of a remote network, a client device, and a cloud server.

21. The method of claim 14, further comprising exchanging encrypted and anonymized cleanser-specific material removal information with at least one of a remote network, a client device, and a cloud server.
